(19) United States
(12) Patent Application Publication
(10) Pub. No.: US 2023/0206237 A1
(43) Pub. Date: Jun. 29, 2023

(54) SYSTEMS AND METHODS FOR REMOTE PAY TRANSACTIONS

(71) Applicant: Mastercard International Incorporated, Purchase, NY (US)

(72) Inventors: Sachin Kumar Singh, Pune (IN); Kaushal Naveen Shetty, Thane (IN)

(73) Assignee: Mastercard International Incorporated, Purchase, NY (US)

(21) Appl. No.: 17/562,604

(22) Filed: Dec. 27, 2021

(51) Int. Cl. G06Q 20/40; G06Q 20/38; G06Q 20/08; G06Q 20/20

(52) U.S. Cl. CPC G06Q 20/40145; G06Q 20/38215; G06Q 20/085; G06Q 20/4016; G06Q 20/20

(57) ABSTRACT

A system receives a remote pay authorization request message from a first consumer. The message includes a transaction token with transaction details. The system also receives first user mapping data from a first issuer. The mapping data includes a unique ID corresponding to a second consumer (i.e., a paying consumer). The system receives a second remote pay authorization request message from the second consumer. The message includes a payment token that includes consumer payment account data. The system also receives second user mapping data from a second issuer. The second user mapping data includes the unique ID. The system determines that the unique ID is included in the first and second user mapping data. The system merges the transaction token and the payment token into a combined payment token, thereby enabling the second consumer to pay for a transaction performed by the first consumer.

### FIELD OF THE DISCLOSURE

The field of the disclosure relates generally to financial transactions and, more particularly, to systems and methods enabling a new mode of payment transaction wherein remote terminals transmit portions of transaction data to a server, and the server merges the transaction data into a single transaction request.

### BACKGROUND OF THE DISCLOSURE

Typically, if a consumer is not carrying his or her payment card, mobile device with a digital wallet, or other payment method, he or she cannot perform a transaction with a merchant. In some instances, a consumer may have already consumed services or goods from a merchant and then realizes that he or she does not have a payment method available, or may be short an amount to cover the total cost of the consumed goods or services. The consumer may be able to call someone to cover the payment amount, but the merchant does not have any way to receive electronic payments by phone.

### BRIEF DESCRIPTION OF THE DISCLOSURE

This brief description is provided to introduce a selection of concepts in a simplified form that are further set forth in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a remote pay server system is provided. The system includes a memory storing computer-executable instructions, and a processor in communication with the memory. The computer-executable instructions cause the processor to receive, from a first point-of-sale (POS) terminal, a first remote pay authorization request message associated with a first consumer. The first remote pay authorization request message includes a remote pay transaction token including transaction details. The computer-executable instructions cause the processor to receive first user mapping data from a first card issuer computing device. The first user mapping data includes a first unique identifier (ID) corresponding to the first consumer. The computer-executable instructions also cause the processor to associate the first user mapping data with the remote pay transaction token. Furthermore, the computer-executable instructions cause the processor to receive, from a second point-of-sale (POS) terminal, a second remote pay authorization request message associated with a second consumer. The second remote pay authorization request message includes a remote pay payment token including consumer payment account data. Moreover, the computer-executable instructions cause the processor to receive second user mapping data from a second card issuer computing device. The second user mapping data includes a second unique ID. The processor determines that the second unique ID is included in the first user mapping data, and based on the determination, merges the remote pay transaction token and the remote pay payment token into a remote pay combined payment token. The remote pay combined payment token includes the transaction details and the consumer payment account data.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example multi-party network system, in accordance with one embodiment of the present disclosure;

FIG. 2 is a simplified block diagram of the example network system, including a remote pay server system;

FIG. 3 is an example configuration of a user system operated by a user, such as a consumer of the multi-party payment card network system shown in FIG. 1;

FIG. 4 is an example configuration of a server system, such as a server system for use in the system shown in FIGS. 1 and 2;

FIG. 5 is a schematic diagram of the payment card network system showing a data flow among the parties during a remote pay transaction, in accordance with one embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

Embodiments of the present technology relate to systems, methods, and computer-readable media for performing a remote pay transaction. As such, a first consumer is able to perform a transaction with a first merchant without requiring the consumer to provide his or her payment details. According to one embodiment of the disclosure, the first consumer initiates a remote pay transaction with the first merchant. A remote pay server system is configured to receive the remote pay transaction authorization request message. A second consumer can also perform an associated remote pay transaction that includes his or her payment details. The remote pay server system matches the first and second consumer's remote pay transactions, based on matching unique IDs, and merges the transaction data into a single payment authorization message. The payment authorization message is sent to the issuer associated with the second consumer for authorization, based on the second consumer's payment details and the first consumer's transaction details. The authorized transaction message is then returned to the first merchant for competition of the transaction.

### Payment Network System

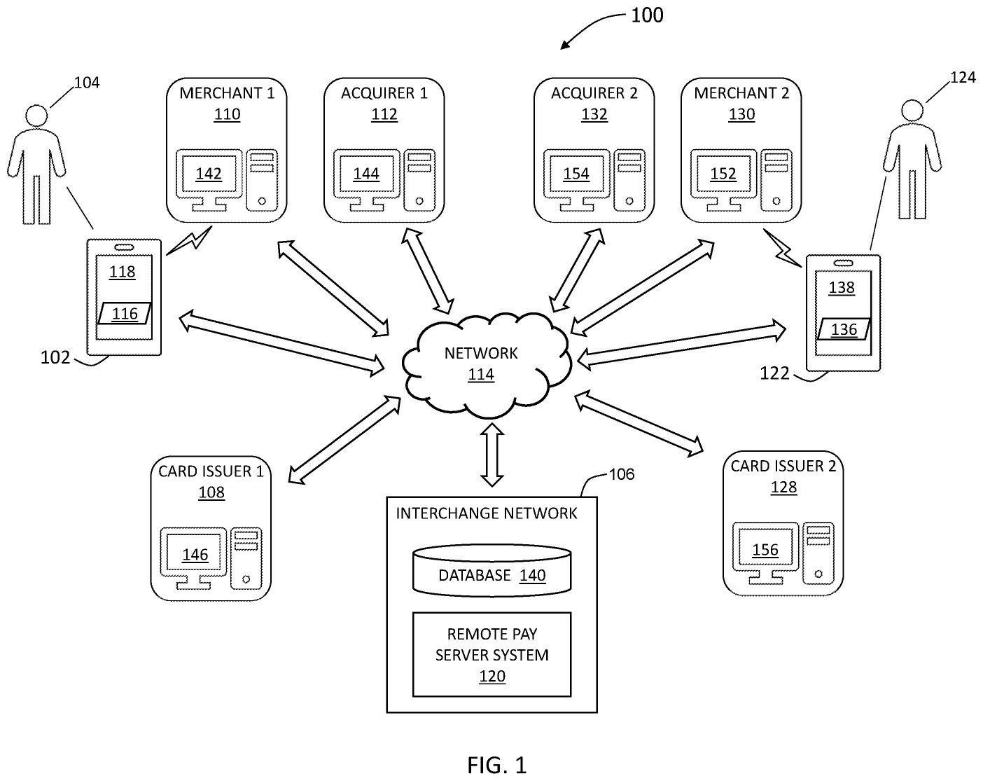

FIG. 1 is a block diagram of an example multi-party network system 100, including a first consumer mobile device 102 belonging to a first consumer 104 and a second consumer mobile device 122 belonging to a second consumer 124, in accordance with one embodiment of the present disclosure. In the exemplary embodiment, the network system 100 provides interchange network services offered by one or more payment networks, such as payment network 106 (broadly, an interchange network). In addition, the network system 100 enables payment card transactions in which consumers 104 and 124, issuers (e.g., card issuers 108 and 128), merchants (e.g., merchants 110 and 130), and/or acquirers (e.g., acquirers 112 and 132) do not need to have a one-to-one relationship. Although parts of the network system 100 are presented in one arrangement, other embodiments may include the same or different parts arranged otherwise, depending, for example, on authorization processes for purchase transactions, communication between computing devices, etc. As used herein, the term “interchange network” includes an electronic network that exchanges data relating to the value of card sales and credits among the card issuers 108, 128 and the acquirers 112, 132 (e.g., networks maintained, for example, by Mastercard®). Mastercard is a registered trademark of Mastercard International Incorporated.

In the example embodiment, the network system 100 generally includes the first and second consumer mobile devices 102 and 122, the payment network 106, the first and second issuers 108 and 128, the first and second merchants 110 and 130, and the first and second acquirers 112 and 132, coupled in communication via a communications network 114. The network 114 includes, for example and without limitation, one or more of a local area network (LAN), a wide area network (WAN) (e.g., the Internet, etc.), a mobile network, a virtual network, and/or any other suitable public and/or private network capable of facilitating communication among the first and second consumer mobile devices 102 and 122, the payment network 106, the first and second issuers 108 and 128, the first and second merchants 110 and 130, and/or the first and second acquirers 112 and 132. In some embodiments, the network 114 includes more than one type of network, such as a private payment transaction network provided by the payment network 106 to the issuers 108 and 128, the merchants 110 and 130, and/or the acquirers 112 and 132 and, separately, the public Internet, which may facilitate communication between the first and second consumer mobile devices 102 and 122, the payment network 106, the merchants 110 and 130, and/or the issuers 108 and 128.

Embodiments described herein relate to transaction card systems, such as a credit card payment system using the Mastercard interchange network. The Mastercard interchange network is a set of proprietary communications standards promulgated by Mastercard for the exchange of financial transaction data and the settlement of funds between financial institutions that are members of Mastercard. As used herein, financial transaction data includes a unique account number associated with an account holder using a payment card or account issued by a card issuer (e.g., the card issuer 108 or 128), and/or a digital wallet application (app), such as the digital wallet app 116 or 136. In addition, the financial transaction data includes purchase data representing a purchase made by the first consumer 104, including a type of merchant, amount of purchase, date of purchase, and other data, which may be transmitted between any parties of the multi-party network system 100.

With continued reference to FIG. 1, in the exemplary embodiment, the first consumer mobile device 102 (e.g., a smartphone or other computing device used by the first consumer 104) includes a first user interface 118 that facilitates user interaction with the respective first consumer mobile device 102. For example, and without limitation, the user interface 118 enables the first consumer 104 to input information to the first consumer mobile device 102 and enables the first consumer mobile device 102 to output information to the first consumer 104 (e.g., on a display of the first consumer mobile device 102). The user interface 118 enables interaction with, for example, a digital wallet app 116, which is installed on the first consumer mobile device 102.

The second consumer mobile device 122 (e.g., a smartphone or other computing device used by the second consumer 124) includes a second user interface 138 that facilitates user interaction with the respective second consumer mobile device 122. For example, and without limitation, the user interface 138 enables the second consumer 124 to input information to the second consumer mobile device 122 and enables the second consumer mobile device 122 to output information to the second consumer 124 (e.g., on a display of the second consumer mobile device 122). The user interface 138 enables interaction with, for example, a digital wallet app 136, which is installed on the second consumer mobile device 122.

In the system 100 described herein, a financial institution called the “card issuer” issues a payment card to a consumer, such as the first and second consumers 104 and 124. The payment card is generally associated with a payment account and includes, for example, a conventional payment card, an integrated circuit (IC) payment card (e.g., an EMV or chip card), a smartcard, and the like. The card issuer, such as the card issuers 108 and 128, associates a phone number (or other device identification information) of the consumer mobile device, such as the consumer mobile devices 102 and 124, and biometric data (biometrics) of the consumer, such as the consumers 104 and 124, together in the respective payment accounts.

The biometric data may include, for example, biometric data associated with the first and second consumers 10 and 124, i.e., one or more scans or digital representations of select physical features of the consumers that are to be validated during authentication requests for remote pay transactions. The biometric data or physical features of the consumers can include, for example, and without limitation, fingerprints, palm prints, facial features, iris features, vein patterns, and the like. The biometric data may be stored, for example, by computers 146 or 156 of the card issuers 108 and 128 and/or in a database, such as the database 140. The computers 146 or 156 of the card issuers 108 and 128 supplement the consumer's accounts or remote pay profiles with the biometric data as master data for subsequent validation/authentication checks. The computers 146 or 156 of the card issuers 108 and 128 issues are programmed to receive the one or more scans or digital representations of physical features from the merchants 110 and 130, as described herein, and use the scans or digital representations to validate the scans or digital representations against the stored biometric data. Validation of the one or more scans or digital representations includes matching the scans or digital representations to the stored biometric data, where a math percentage or value is above a predetermined threshold value.

The first consumer 104 uses the phone number of the first consumer mobile device 102 and his or her biometric data to request payment for goods or services provided by the first merchant 110 from the second consumer 124. In response to the request, the second consumer 124 uses the second consumer mobile device 122, for example, the digital wallet app 136, to tender payment for the purchase made from the first merchant 110. In the example embodiment, the first merchant 110 is typically associated with goods and/or services that are offered for sale and are sold to the first consumer 104. The first merchant 110 includes, for example, a physical location and/or a virtual location. A physical location includes, for example, a brick-and-mortar store, etc., and a virtual location includes, for example, an Internet-based store-front.

With respect to the digital wallet apps 116 and 136, the first and second consumer mobile devices 102 and 122 communicate with a wallet service provider (not shown), for example, via the network 114, to synchronize financial data with respective digital wallet accounts (not shown) stored by or otherwise accessible to the digital wallet apps 116 and 136. The wallet service provider may also access the network 114 to communicate with the issuers 108 and 128 and/or the acquirers 112 and 132, via the payment network 106, to facilitate the exchange of funds and other financial data between the acquirers 112 and 132 and the consumer's accounts at the issuers 108 and 128. In addition, the wallet service provider communicates with the issuers 108 and 128 to exchange and/or synchronize financial data with the digital wallet accounts.

Each of the consumer mobile devices 102 and 122 can be any computing device capable of interconnecting to the network 114, such as the Internet, including a mobile web-based device, smartphone, PDA, or other mobile web-based connectable equipment. More preferably, the consumer mobile devices 102 and 122 are interconnected to the Internet through one or more interfaces including a network, such as a local area network (LAN) or a wide area network (WAN), dial-in-connections, cable modems, wireless modems, and special high-speed ISDN lines.

In the exemplary embodiment, the network system 100 also includes the remote pay server system 120, which is part of the payment network 106 and is coupled in communication to the network 114. The remote pay server system 120 is a computer including, for example, a web application, an application programming interface (API) server, and a memory device, enabling the remote pay server system 120 to be in communication with the issuers 108 and 128 and/or the acquirers 112 and 132 using, for example, and without limitation, the Internet. The remote pay server system 120 is interconnected to the Internet through one or more interfaces including a network, such as a local area network (LAN) or a wide area network (WAN), dial-in-connections, cable modems, and special high-speed ISDN lines. The remote pay server system 120 can be any computing device capable of interconnecting to the Internet. In certain embodiments of the present invention, the wallet service provider is integrated with or is otherwise a part of the remote pay server system 120. In such an embodiment, the wallet service provider can communicate directly with the payment network server system and any other payment network server systems via the communication network 114.

The payment network 106 includes, for example, a database 140, which is connected to the remote pay server system 120. In one embodiment, the database 140 is stored on the remote pay server system 120 and can be accessed by the first or second consumers 104 and 124 by logging onto the remote pay server system 120, using, for example, the digital wallet apps 116 and 136, respectively. In an alternative embodiment, the database 140 may be stored remotely from the remote pay server system 120 and may be non-centralized. The database 140 is configured to receive and store consumer accounts, transaction requests and data, and rules associated with those accounts to enable a transaction performed by the first consumer 104 to be paid by a payment account of the second consumer 124.

In the exemplary embodiment, to accept payment with the payment card or the digital wallet apps 116 and 136, the merchants 110 and 130 must normally establish an account with a financial institution that is part of the payment card network system 100. This financial institution is usually called the “merchant bank,” the “acquiring bank,” or the “acquirer” (e.g., the acquirers 112 and 132). When consumers 104 or 124 provide payment for a purchase with the payment card or digital wallet, the merchant 110 or 130 requests authorization from the acquirer 112 or 132 for the purchase amount. The request may be performed over the telephone but is usually performed using a point-of-sale (POS) terminal, for example, a first POS terminal 142 (associated with the first merchant 110) or a second POS terminal 152 (associated with the second merchant 130), that connects to the payment card or digital wallet. The POS terminal 142 or 152 reads the consumer's payment account information, such as the card identification number, expiration date, etc. from a magnetic stripe and/or an integrated circuit chip on the payment card (or a payment token from the digital wallet apps 116 or 136) and communicates electronically with the transaction processing computers of the acquirers 112 or 132. Alternatively, the acquirer 112 or 132 may authorize a third party to perform transaction processing on its behalf. In this case, the POS terminal 142 or 152 will be configured to communicate with the third party. Such a third party is usually called a “merchant processor,” an “acquiring processor,” or a “third party processor.”

In the exemplary embodiment, computers 144 or 154 of the acquirers 112 or 132, respectively, or the merchant processors communicate with the interchange network 106 to relay authorization requests and responses messages between the merchants 110 or 130 (e.g., via the POS terminals 142 or 152) and the card issuer 108 or 128. The interchange network 106 analyzes the incoming authorization requests to determine whether to send them to the remote pay server system 120 or directly to the card issuer 108 or 128. For example, a selected data element for a given authorization request is extracted or otherwise read from the authorization request. Where the data element indicates that the transaction is a remote pay transaction, the interchange network 106 creates a temporary data lobby (e.g., a selected location in memory) to store the transaction details (i.e., a remote pay transaction token). The interchange network 106 communicates with the issuer associated with the authorization request to authenticate the consumer and/or consumer payment account data and to request member data associated with the consumer and his or her remote pay group. The issuers maintain a list of consumer data (e.g., mobile number, biometric data, card identification numbers, etc.) associated with the consumers who are registered with the remote pay service. When the interchange network 106 receives a second authorization request for a remote pay transaction, the interchange network attempts to match the two requests based on the remote pay group information. If there is a match based on the comparison of the remote pay group information, the two separate authorization requests (or tokens) are merged into a single authorization request, which is routed to the issuer associated with the paying consumer for further processing.

In the exemplary embodiment, using the interchange network 106, the computers 144 and 154 of the acquirers 112 and 132 or the merchant processors communicate with computers 146 or 156 of the card issuers 108 and 128 to determine whether the consumer's accounts are in good standing and whether the purchase is covered by the consumer's available credit line. Based on these determinations, the request for authorization will be declined or accepted. If the request is accepted, an authorization code is transmitted to the merchant, such as the first merchant 110.

When a request for authorization is approved by the card issuers 108 or 128, the available credit line of the consumer's account is decreased. Normally, a charge for a payment card transaction is not posted immediately to the consumer's account because bankcard associations, such as Mastercard, have promulgated rules that do not allow the merchant to charge, or “capture,” a transaction until the purchased goods are shipped or the purchased services are delivered. However, with respect to at least some debit card transactions, a charge may be posted at the time of the transaction. When the merchant ships or delivers the goods or services, the merchant captures the transaction by, for example, appropriate data entry procedures on the POS terminal, such as POS terminal 142 or 152. This may include bundling of approved transactions daily for standard retail purchases. The interchange network 106 and/or the card issuers 108 and 128 store, in a transaction database, such as the database 140, the financial transaction data, such as, and without limitation, the card identification number, a type of merchant, a merchant identifier, a location where the transaction was completed, an amount of purchase, a merchant category code, a date and time of the transaction, products purchased and related descriptions or identifiers, etc.

After a purchase has been completed, a clearing process occurs to transfer additional financial transaction data related to the purchase among the transacting parties, such as the acquirers 112 and 132, the interchange network 106, and the card issuers 108 and 128. More specifically, during and/or after the clearing process, additional data, such as a time of purchase, a merchant name, a type of merchant, purchase information, consumer account information, a type of transaction, information regarding the purchased item and/or service, and/or other suitable information, is associated with a transaction and transmitted between the transacting parties, as financial transaction data, and may be stored by any of the transacting parties.

After a transaction is authorized and cleared, the transaction is settled among the merchant 110, the acquirer 112, and the card issuers 108 and 128. Settlement refers to the transfer of financial data or funds among the merchant 110, the acquirer 112, and the card issuers 108 and 128 related to the transaction. Usually, transactions are captured and accumulated into a “batch,” which is settled as a group. More specifically, a transaction is typically settled between the card issuers 108 and 128 and the interchange network 106, and then between the interchange network 106 and the acquirers 112 and 132, and then between the acquirers 112 and 132 and the merchants 110 and 130. It should be appreciated that more or less information related to transactions, as part of either authorization, clearing, and/or settling, may be included in the financial transaction data and stored in the transaction database 140, at the merchants 110 and 130, at the acquirers 112 and 132, at the payment network 106, and/or at the card issuers 108 and 128. Further, financial transaction data, unrelated to a particular payment account, may be collected by a variety of techniques, and similarly stored in the transaction database.

In some embodiments, the consumers 104 and 124 involved in the transactions described herein are prompted to agree to legal terms associated with their payment accounts, for example, during enrollment in such payment accounts, etc. As such, the first and second consumers 104 and 124 may voluntarily agree to allow the merchants 110 and 130, the card issuers 108 and 128, the interchange network 106, etc., to utilize data collected relating to processing the transactions, subsequently for one or more of the purposes described herein.

While only certain numbers of the first and second consumers 104 and 124, the merchants 110 and 130, the acquirers 112 and 132, interchange network 106, and the issuers 108 and 128 are shown in FIG. 1 (for ease of reference), it should be appreciated that a variety of other embodiments may include any number of these parties in various combinations.

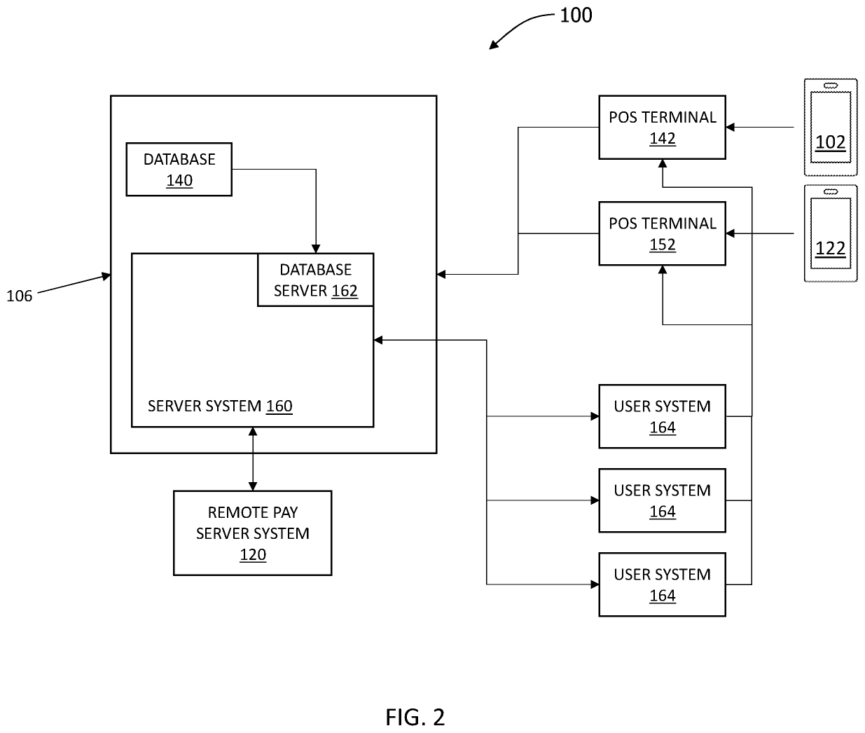

FIG. 2 is a simplified block diagram of the payment network 100 including the remote pay server system 120. The payment network 100 includes a plurality of computing devices connected in accordance with the present disclosure. The payment network 100 includes a server system 160 of the interchange network 106 coupled in communication with one or more POS terminals 142 and 152 located, for example, at merchants 110 and 130, respectively (shown in FIG. 1), and/or other user systems 164 associated with merchants, merchant banks, payment networks, and/or issuer banks.

More specifically, in the example embodiment, the interchange network 106 includes the server system 160 coupled in communication with the POS terminals 142 and 152 and the user systems 164 associated with merchants, merchant banks, payment networks, and/or issuer banks. The server system 160 is also coupled in communication with a plurality of client sub-systems, also referred to as the user systems 164. In one embodiment, the user systems 164 are computers including a web browser, such that server system 160 is accessible to the user systems 164 using the Internet. The user systems 164 are interconnected to the Internet through one or more of many interfaces including, for example, a network, such as a LAN or WAN, dial-in-connections, cable modems, and/or special high-speed Integrated Services Digital Network (ISDN) lines. The user systems 164 could be any device capable of interconnecting to the Internet, including an Internet connected phone, a PDA, or any other suitable web-based connectable equipment.

In the example embodiment, the interchange network 106 also includes communication with one or more of the POS terminals 142 and 152, which may be connected to the user systems 164 and may be connected to the server system 160. The POS terminals 142 and 152 may be interconnected to the Internet (or any other network that allows the POS terminals 142 and 152 to communicate as described herein) through many interfaces including a network, such as a local area network (LAN) or a wide area network (WAN), dial-in-connections, cable modems, wireless modems, and special high-speed ISDN lines. Each of the POS terminals 142 and 152 is any device capable of interconnecting to the Internet and including an input device capable of reading information from a consumer's financial payment card and/or digital wallet. In some embodiments, each of the POS terminals 142 and 152 may be a consumer's personal computing device (e.g., consumer mobile devices 102 and 122), such as when conducting an online purchase through the Internet. As used herein, the terms POS device, POS terminal, and point-of-interaction device are used broadly, generally, and interchangeably to refer to any device in which a consumer interacts with a merchant to complete a payment card transaction.

A database server 162 is connected to the database 140, which is configured to store information on a variety of matters, including account information indicating whether the consumers 104 and 124 are registered with the registered with the remote pay service before processing transactions as described below in greater detail. In one embodiment, the database 140 is a centralized database stored on the server system 160 and can be accessed by potential users at one of the user systems 164 by logging onto the server system 160 through one of the user systems 164. In an alternative embodiment, the database 140 is stored remotely from the server system 160 and may be a distributed or non-centralized database.

In one example embodiment, the database 140 may include a single database having separated sections or partitions or may include multiple databases, each being separate from each other. The database 140 may store financial transaction data generated as part of sales activities and savings activities conducted over the processing network. Such financial transaction data may include data relating to merchants, account holders or customers, issuers, acquirers, savings amounts, savings account information, and/or purchases made. The database 140 may also store account data including at least one of a consumer name, a consumer address, an account number, and other account identifier. The database 140 may also store merchant data including a merchant identifier that identifies each merchant registered to use the network, and instructions for settling transactions including merchant bank account information. The database 140 may also store purchase data associated with items being purchased by a consumer from a merchant, authorization request data for remote pay transactions, and consumer data associated with the remote pay server system 120. The database 140 may also store consumer mobile device information (e.g., phone number, device ID, etc.), payment card information, and other data involved with processing transactions between one or more parties.

In the example embodiment, one or more of the user systems 164 may be associated with the acquirers 112 and 132 (shown in FIG. 1) while one or more of the user systems 164 may be associated with the issuers 108 and 128 (shown in FIG. 1). The POS terminals 142 and 152 may be associated with the merchants 110 and 130, respectively (shown in FIG. 1) or may be a computer system and/or mobile system used by the consumers 104 or 124 when participating in a remote pay purchase, payment, or transaction. The server system 160 may be associated with the interchange network 106 or a payment processor. In the example embodiment, the server system 160 is associated with a financial transaction processing network, such as the interchange network 106, and may be referred to as an interchange computer system. The server system 160 may be used for processing financial transaction data. In addition, the user systems 164 and the POS terminals 142 and 152 may include a computer system associated with at least one of a merchant, an online bank, a bill payment outsourcer, an acquirer bank, an acquirer processor, an issuer bank associated with a payment card, an issuer processor, a remote payment processing system, and/or a biller.

In the example embodiment, the interchange network 106 is in communication with the remote pay server system 120, which may be associated with the interchange network 106 or with an outside third party in a contractual relationship with the interchange network 106. In the example embodiment, the remote pay server system 120 reads and/or extracts PANs from payment transaction messages, and in particular, from payment authorization request messages, and processes the authorization request messages to determine if a remote pay transaction is being requested before processing the transaction. The database 140 and/or the issuers 108 and 128 provide account information corresponding to the account associated with the payment transaction, including whether a remote pay transaction is being requested, before processing the transactions. In some embodiments, the remote pay server system 120 is also in communication with an issuer system (e.g., the user systems 164 and/or the computers 146 or 156 of the card issuers 108 and 128). It is noted that the payment network 100 may include more, fewer, or alternative components and/or perform more, fewer, or alternative actions, including those discussed elsewhere herein.

### Exemplary Computer Systems

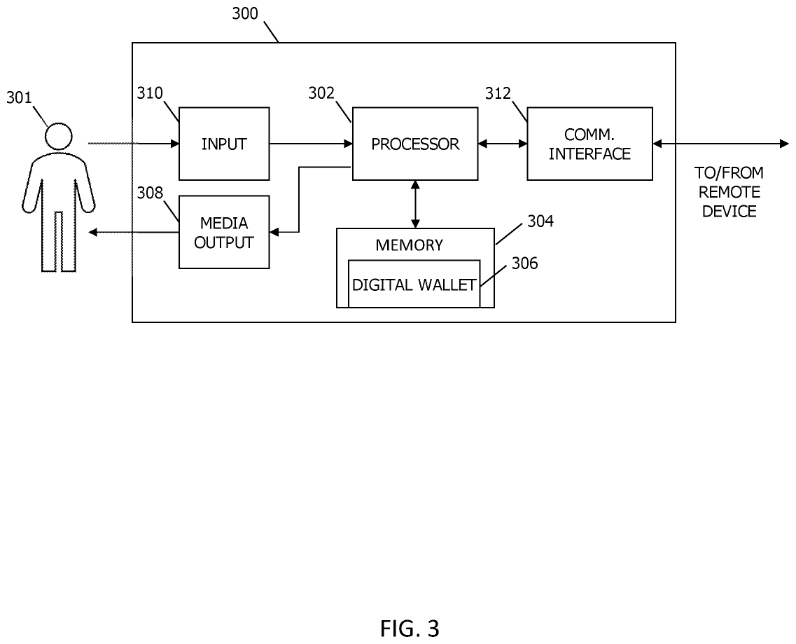

FIG. 3 is an example configuration of a user system 300 operated by a user 301, such as the consumers 104 and 124 (shown in FIG. 1). In some embodiments, the user system 300 is a consumer mobile device 102 or 122, a client system 164, and/or a merchant POS terminal 142 or 152. In the example embodiment, the user system 300 includes a processor 302 for executing instructions. In some embodiments, executable instructions are stored in a memory device 304. The processor 302 includes one or more processing units arranged, for example, in a multi-core configuration. The memory device 304 is any device allowing information such as the digital wallet data 306, executable instructions, and/or written works to be stored and retrieved. The memory device 304 includes one or more computer readable media.

The user system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the user system 300 includes an input device 310 for receiving input from the user 301. The input device 310 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 308 and the input device 310. The user system 300 may also include a communication interface 312, which is communicatively connectable to a remote device such as the server system 160 and/or the POS terminals 142 and 152 (shown in FIG. 2). The communication interface 312 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface, such as the interfaces 118 and 138 (shown in FIG. 1), to the user 301 via the media output component 308 and, optionally, receiving and processing input from the input device 310. A user interface may include, among other possibilities, a web browser and a client application. Web browsers enable users, such as the user 301, to display and interact with media and other information typically embedded on a web page or a website from the server system 160. A client application allows the user 301 to interact with a server application from the server system 160.

In the example embodiment, the computing system 300 is a user computing device from which the user 301 engages with a digital wallet 306 (e.g., the digital wallet apps 116 and 136 shown in FIG. 1), an online merchant (e.g., the merchants 110 and 130 shown in FIG. 1), an interchange network (e.g., the interchange network 106 shown in FIG. 1), and an issuer of a payment card (e.g., the issuers 108 and 128 shown in FIG. 1) to perform remote pay transactions.

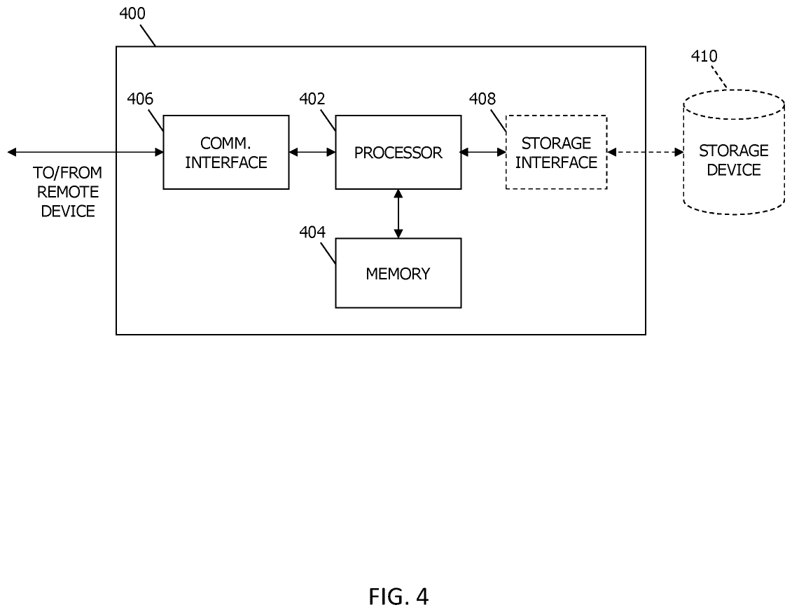

FIG. 4 is an example configuration of a server system 400, such as the server system 160 (shown in FIG. 2). The server system 400 includes, but is not limited to, the database 140 (shown in FIG. 1) and/or the remote pay server system 120. In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as a user system 300 (shown in FIG. 3) or another server system. For example, the communication interface 406 may receive communications from a client system 164 via the Internet, as illustrated in FIG. 2.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the database 140. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In the example embodiment, server system 400 is a remote pay server system in communication with one or more of the issuers 108 and 128, the acquirers 112 and 132, and the merchants 110 and 130 during a remote pay transaction involving a transaction performed by a first consumer 102 (shown in FIG. 1) and a digital wallet app 136 (shown in FIG. 1) of a second consumer 124 (shown in FIG. 1). The server system 400 checks for account information updates for accounts initiating a payment transaction and provides updated account information indicators to a merchant associated with the payment transaction.

### Exemplary Data Flow and Computer-Implemented Methods

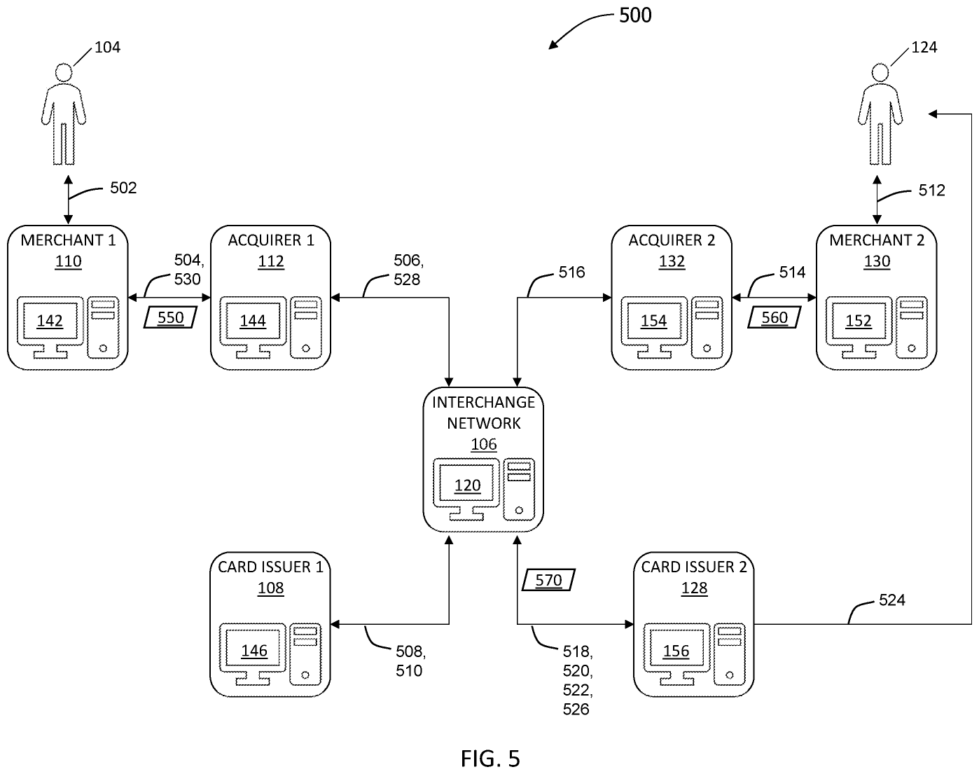

FIG. 5 is a schematic diagram of the payment card network system showing data flow 500 among the parties during a remote pay transaction. The data flow and operations described herein may be performed in the order described herein and depicted in FIG. 5 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The data flow 500 and computer-implemented method is described below, for ease of reference, as being executed by exemplary devices and components introduced with the embodiments illustrated in FIGS. 1-4. In one embodiment, the remote pay processing technique is implemented by the remote pay server system 120. In the exemplary embodiment, the data flow 500 relates to a payment transaction where the first consumer 104 initiates a remote pay transaction using for example, and without limitation, a phone number and biometric data to purchase goods or services associated with the first merchant 110. More particularly, the first consumer 104 initiates a transaction request for the second consumer 124 to electronically transact with the second merchant 130, so that the purchase of the goods or services associated with the first merchant 110 is completed. While operations within the data flow 500 are described below regarding the remote pay server system 120, according to some aspects of the present invention, the data flow and computer-implemented methods may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the example embodiment, the first merchant 110 includes the POS terminal 142. When the first consumer 104 selects to initiate a remote pay transaction with the first merchant 110, the first consumer 104 transmits a remote pay request 502 to the first merchant 110, for example, and without limitation, by the Internet or by radio transmission from the first consumer mobile device 102 and/or via the POS terminal 142. The remote pay request 502 includes, for example, identification data (broadly, a device identifier (ID)) of the first consumer mobile device 102 (e.g., a phone number, an Electronic Serial Number (ESN), Mobile Equipment Identifier (MEID), International Mobile Equipment Identity (IMEI) number, and the like) and biometric data of the first consumer 104.

Upon receipt of the remote pay request 502, the merchant 110 (via the POS terminal 142 and/or a user system 164) generates a remote pay transaction token 550, which includes, for example, transaction details related to goods and/or services provided by the first merchant 110. The transaction details include, for example, a terminal ID of the POS terminal 142, a merchant ID, and a cost or amount of the transaction. The remote pay transaction token 550, however, preferably does not include consumer payment account data or other consumer payment details for completing a payment.

The merchant 110 then generates a remote pay authorization request message 504, flags it as being a remote pay authorization request via a predetermined data element (e.g., a binary data element where a “1” indicates a remote pay transaction or a “0” indicates a non-remote pay transaction, or the like), and transmits the message to the first acquirer 112. The remote pay authorization request message 504 includes, for example, the biometric data of the first consumer 104, the device ID of the first consumer mobile device 102, and the remote pay transaction token 550.

The first acquirer 112 receives the remote pay authorization request message 504 and, at step 506, transmits it to the interchange network 106. It is noted that the messages within an interchange network such the interchange network 106, may, in at least some instances, conform to the International Organization for Standardization (ISO) Standard 8583, Financial transaction card originated messages—Interchange message specifications, which is the ISO standard for systems that exchange electronic transactions made by cardholders using payment cards. In the example embodiment, the payment authorization request message 506 can be an ISO 8583 message type identifier (MTI) 0100 message.

Upon receipt of the remote pay authorization request message 504, the interchange network 106, and more particularly, the remote pay server system 120, analyzes the remote pay authorization request message and extracts or otherwise reads the predetermined data element indicating that the authorization request message 504 request is for a remote pay transaction. Where the data element indicates that the transaction is a remote pay transaction, the interchange network 106 creates a first temporary data lobby (e.g., in the database 140, memory 404, or the like) to store the transaction details (i.e., remote pay transaction token 550).

The interchange network 106 extracts the biometric data of the first consumer 104 and the device ID of the first consumer mobile device 102 from the remote pay authorization request message 504. The interchange network 106 generates a user authentication request message 508 and transmits it to the first card issuer 108 associated with the first consumer 104. The user authentication request message 508 includes the biometric data of the first consumer 104 and the device ID of the first consumer mobile device 102, a request to authenticate the first consumer 104 based, at least in part, on the biometric data and the device ID, and a request for user mapping data for the remote pay service.

The first card issuer 108 authenticates the first consumer 104 by verifying that the device ID of the first consumer mobile device 102 is registered with the remote pay service and a corresponding consumer, and then by comparing the received biometric data of the first consumer 104 to a user biometric profile associated with the corresponding consumer. If the device ID is valid and the biometric data matches the corresponding consumer, the first card issuer 108 transmits an authentication response message 510 to the interchange network 106. The authentication response message 510 includes, for example, an authentication data element and first user mapping data for the remote pay service. The first user mapping data may include, for example, a unique identifier corresponding to the first consumer 104 and one or more unique identifiers corresponding to respective associated consumers, such as the second consumer 124, that are mapped to the first consumer 104 for remote pay transactions.

Upon receipt of the first user mapping data, the interchange network 106 tags or otherwise associates the first user mapping data with the temporary first data lobby, and in particular to the transaction details or remote pay transaction token 550. In certain embodiments, the interchange network 106 may also set a predetermined time limitation to maintain the first temporary data lobby (i.e., the transaction details or remote pay transaction token 550). The time limitation is a predetermined period for which the remote pay transaction is to be completed. If the interchange network 106 does not receive the related payment data for the remote pay transaction, as described below, within the predetermined period, the transaction will be canceled and the transaction details deleted.

Further, upon receipt of the user authentication request message 508, the first card issuer 108 also notifies the associated consumers identified in the first user mapping data, such as the second consumer 124, that a request for remote pay has been submitted by the first consumer 104. The notifications may be transmitted, for example, via email, text message, phone call, or any other messaging technique that enables notification to be accomplished. Alternatively, or additionally, the first consumer 104 notifies the associated consumers, such as the second consumer 124, that he or she submitted a request for remote pay.

In the example embodiment, the second merchant 130 includes the POS terminal 152. When the second consumer 124 receives notification that a member of his or her remote pay group has selected to initiate a first remote pay transaction, for example, with the first merchant 110, the second consumer 124 may initiate a second remote pay transaction with the second merchant 130 to pay for the remote pay transaction of the first consumer 104. The second consumer 124 transmits a remote pay request 512 to the second merchant 130, for example, and without limitation, by the Internet or by radio transmission from the second consumer mobile device 122 and/or via the POS terminal 152. The remote pay request 512 includes, for example, biometric data of the second consumer 124, a device ID of the second consumer mobile device 124 (e.g., a phone number, an Electronic Serial Number (ESN), Mobile Equipment Identifier (MEID), International Mobile Equipment Identity (IMEI) number, and the like), and payment account data (e.g., a primary account number (PAN), a virtual payment number, limited use number, etc.) associated with a payment account of the second consumer 124.

Upon receipt of the remote pay request 512, the second merchant 130 (via the POS terminal 152 and/or a user system 164) generates a remote pay payment token 560, which includes, for example, the consumer payment account data. The merchant 130 then generates a remote pay authorization request message 514, flags it as being a remote pay authorization request via a predetermined data element, and transmits the message to the second acquirer 132. The remote pay authorization request message 514 includes, for example, the biometric data of the second consumer 124, the device ID of the second consumer mobile device 122, and the remote pay payment token 560. The second acquirer 132 receives the remote pay authorization request message 514 and, at step 516, transmits it to the interchange network 106.

Upon receipt of the remote pay authorization request message 514, the interchange network 106, and more particularly, the remote pay server system 120, analyzes the remote pay authorization request message 514 and extracts or otherwise reads the predetermined data element indicating that the authorization request message 514 request is for a remote pay transaction. Where the data element indicates that the transaction is a remote pay transaction, the interchange network 106 creates a second temporary data lobby to store the transaction details (i.e., remote pay transaction token 550).

The interchange network 106 sends a user authentication request message 518 to the second card issuer 128 associated with the second consumer 124. The user authentication request message 518 includes the biometric data of the second consumer 124 and the device ID of the second consumer mobile device 122 for authentication, and a request for user mapping data for the remote pay service.

The second card issuer 128 authenticates the second consumer 124 by verifying that the device ID of the second consumer mobile device 122 is registered with the remote pay service and a corresponding consumer, and then by comparing the received biometric data of the second consumer 124 to a user biometric profile associated with the corresponding consumer. If the device ID is valid and the biometric data matches the corresponding consumer, the second card issuer 128 transmits an authentication response message 520 to the interchange network 106. The authentication response message 520 includes, for example, an authentication data element and second user mapping data for the remote pay service. The second user mapping may include, for example, a unique identifier corresponding to the second consumer 124 and one or more unique identifiers corresponding to associated consumers, such as the first consumer 104, that are mapped to the second consumer 124 for remote pay transactions.

Upon receipt of the second user mapping data, the interchange network 106 tags or otherwise associates the second user mapping data with the second temporary data lobby. In certain embodiments, the interchange network 106 may also set a predetermined time limitation to maintain the second temporary data lobby (i.e., the transaction details or remote pay transaction token 550). The time limitation is a predetermined period for which the remote pay transaction is to be completed. If the interchange network 106 does not receive the related transaction details for the remote pay transaction within the predetermined period, the transaction will be canceled and the payment data deleted.

The interchange network 106, and more particularly, the remote pay server system 120, matches the unique identifiers of the first and second consumers 104 and 124 (associated with the data lobbies, for example) based on the user mapping data received from the first and second issuers 108 and 128. For example, the remote pay server system 120 determines that the unique identifier corresponding to the second consumer 124 contained in the second user mapping data is also included in the first user mapping data. Upon a successful match, the remote pay server system 120 merges the transaction token 550 and the payment token 560 into a remote pay combined payment token 570. The remote pay server system 120 generates a payment authorization request message 522 and transmits it to the second issuer 128 for authorization. The payment authorization request message 522 includes, for example, the transaction details from the transaction token 550 (e.g., a terminal ID of the POS terminal 142, a merchant ID of the first merchant 110, and a cost or amount of the transaction) and the consumer payment account data from the payment token 560 (e.g., the PAN, virtual payment number, limited use number, etc. associated with a payment account of the second consumer 124).

Upon receipt of the payment authorization request message 522, the second card issuer 128 generates a one-time password (OTP) and transmits it to the second consumer 124 at step 524. The OTP is input into the POS terminal 152 to continue the transaction. The OTP is passed to the second card issuer 128, for example, via the second acquirer 132 and the interchange network 106. Upon receipt of the OTP from the second consumer 124, the second card issuer 128 verifies that it matches the generate OTP. Upon a successful match, the second card issuer 128 transmits a payment authorization response message 526 to the interchange network 106 authorizing the payment transaction. The payment authorization response message is then transmitted to the first merchant 110 for completion of the remote pay transaction. In the example embodiment, the payment authorization response message 526 can be an ISO 8583 message type identifier (MTI) 0110 message. In certain embodiments of the present invention, the interchange network 106 transmits a transaction status message to both the POS terminals 142 and 152, indicating, for example, whether the remote pay transaction was authorized or denied by the second issuer 128.

While the data flow and computer-implemented methods are described above with the first consumer 104 initiating the remote pay transaction, certain additional aspects of the present invention contemplate the second consumer 124 initiating the remote pay transaction, for example, at the request of the first consumer 104. For example, the second consumer 124 may initiate the second remote pay transaction with the second merchant 130 to pay for an anticipated remote pay transaction performed by the first consumer 104. The process progresses as described above up to the second card issuer 128 authenticating the second consumer 124 and transmitting the authentication response message 520 to the interchange network 106, including the user mapping data for the remote pay service. The first consumer 104 may then perform a remote pay transaction with the first merchant 110. Thereafter, the process progresses as described above. After the interchange network 106 receives both the authentication response messages 510 and 520, the remote pay transaction is completed substantially as described above.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A remote pay server system comprising:
a memory comprising computer-executable instructions; and
a processor in communication with said memory, the computer-executable instructions causing the processor to perform operations comprising:
receiving, from a first point-of-sale (POS) terminal, a first remote pay authorization request message associated with a first consumer, the first remote pay authorization request message including first biometric data associated with the first consumer, a first device ID associated with a first consumer mobile device of the first consumer, and a remote pay transaction token including transaction details, the first remote pay authorization request message comprising a first International Organization for Standardization (ISO) Standard 8583 message type identifier (MTI) 0100 message;
extracting the first biometric data and the first device ID from the first remote pay authorization request message;
generating a first user authentication request message, the first user authentication request message including the first biometric data, the first device ID, a request to authenticate the first consumer based on the biometric data and the device ID, and a request for user mapping data;
transmitting the first user authentication request message to a first card issuer computing device for authenticating the first consumer;
receiving first user mapping data from the first card issuer computing device, the first user mapping data including a first unique identifier (ID) corresponding to a first consumer;
associating the first user mapping data with the remote pay transaction token;
receiving, from a second point-of-sale (POS) terminal, a second remote pay authorization request message associated with a second consumer, the second remote pay authorization request message including a remote pay payment token including consumer payment account data, the second remote pay authorization request message comprising a second ISO Standard 8583 MTI 0100 message;
receiving second user mapping data from a second card issuer computing device, the second user mapping data including a second unique ID;
determining that the second unique ID is included in the first user mapping data; and
based on the determination, merging the remote pay transaction token and the remote pay payment token into a remote pay combined payment token, the remote pay combined payment token including the transaction details and the consumer payment account data.

2. The remote pay server system in accordance with claim 1,
said computer-executable instructions causing the processor to perform operations comprising:
generating a first temporary data lobby in a memory; and
storing the remote pay transaction token in the first temporary data lobby,
wherein said operation of associating the first user mapping data with the remote pay transaction token comprises associating the first user mapping data with the first temporary data lobby.

3. The remote pay server system in accordance with claim 2,
said computer-executable instructions causing the processor to perform an operation comprising setting a predetermined time limitation to maintain the first temporary data lobby in the memory.

4. The remote pay server system in accordance with claim 2,
said computer-executable instructions causing the processor to perform operations comprising:
generating a second temporary data lobby in the memory;
storing the remote pay payment token in the second temporary data lobby; and
associating the second user mapping data with the remote pay payment token.

5. The remote pay server system in accordance with claim 4,
said operation of associating the second user mapping data with the remote pay payment token comprises associating the second user mapping data with the second temporary data lobby.

6. The remote pay server system in accordance with claim 4,
said computer-executable instructions causing the processor to perform operations comprising:
generating a payment authorization request message, the payment authorization request message including the combined payment token;
transmitting the payment authorization request message to the second card issuer computing device;
receiving a payment authorization response message from the second card issuer computing device authorizing the payment transaction; and
transmitting the payment authorization response message to the first POS terminal.

7. The remote pay server system in accordance with claim 1,
said first remote pay authorization request message further including a first data element indicating that the first remote pay authorization request message is associated with a remote pay transaction,
said computer-executable instructions causing the processor to perform operations comprising:
analyzing the first remote pay authorization request message;
reading the first data element;
in response to the reading, generating a first temporary data lobby in a memory; and
storing the remote pay transaction token in the first temporary data lobby.

8. The remote pay server system in accordance with claim 7,
said computer-executable instructions causing the processor to perform an operation comprising setting a predetermined time limitation to maintain the first temporary data lobby in the memory.

9. The remote pay server system in accordance with claim 7,
said second remote pay authorization request message further including a second data element indicating that the second remote pay authorization request message is associated with a remote pay transaction,
said computer-executable instructions causing the processor to perform operations comprising:
analyzing the second remote pay authorization request message;
reading the second data element;
in response to the reading, generating a second temporary data lobby in the memory; and
storing the remote pay transaction token in the second temporary data lobby.

10. The remote pay server system in accordance with claim 9,
said computer-executable instructions causing the processor to perform an operation comprising setting a predetermined time limitation to maintain the second temporary data lobby in the memory.

11. The remote pay server system in accordance with claim 9,
said operation of receiving the first user mapping data from the first card issuer computing device comprising, upon the first card issuer computing device authenticating the first consumer, receiving the first user mapping data in a first authentication response message.

12. The remote pay server system in accordance with claim 11,
said second remote pay authorization request message further including second biometric data associated with the second consumer and a second device ID associated with a second consumer mobile device of the second consumer,
said computer-executable instructions causing the processor to perform operations comprising:
extracting the second biometric data and the second device ID;
generating a second user authentication request message, the second user authentication request message including the second biometric data and the second device ID; and
transmitting the second user authentication request message to the second card issuer computing device for authenticating the first consumer,
said operation of receiving the second user mapping data from the second card issuer computing device comprising, upon the second card issuer computing device authenticating the second consumer, receiving the second user mapping data in a second authentication response message.

13. The remote pay server system in accordance with claim 12,
said computer-executable instructions causing the processor to perform operations comprising:
generating a payment authorization request message, the payment authorization request message including the combined payment token; and
transmitting the payment authorization request message to the second card issuer computing device.

14. The remote pay server system in accordance with claim 13,
said computer-executable instructions causing the processor to perform an operation comprising:
receiving a payment authorization response message from the second card issuer computing device authorizing the payment transaction; and
transmitting the payment authorization response message to the first POS terminal.

15. The remote pay server system in accordance with claim 1,
said operation of receiving the first user mapping data from the first card issuer comprising, upon the first card issuer authenticating the first consumer, receiving the first user mapping data in a first authentication response message.

16. The remote pay server system in accordance with claim 15,
said second remote pay authorization request message further including second biometric data associated with the second consumer and a second device ID associated with a second consumer mobile device of the second consumer,
said computer-executable instructions causing the processor to perform operations comprising:
extracting the second biometric data and the second device ID;
generating a second user authentication request message, the second user authentication request message including the second biometric data and the second device ID; and
transmitting the second user authentication request message to the second card issuer for authenticating the first consumer,
said operation of receiving the second user mapping data from the second card issuer comprising, upon the second card issuer authenticating the second consumer, receiving the second user mapping data in a second authentication response message.

17. The remote pay server system in accordance with claim 16,
said computer-executable instructions causing the processor to perform operations comprising:
generating a payment authorization request message, the payment authorization request message including the combined payment token; and
transmitting the payment authorization request message to the second card issuer computing device.

18. The remote pay server system in accordance with claim 17,
said computer-executable instructions causing the processor to perform an operation comprising:
receiving a payment authorization response message from the second card issuer computing device authorizing the payment transaction; and
transmitting the payment authorization response message to the first POS terminal.

19. The remote pay server system in accordance with claim 1,
said computer-executable instructions causing the processor to perform operations comprising:
generating a payment authorization request message, the payment authorization request message including the combined payment token; and
transmitting the payment authorization request message to the second card issuer computing device.

20. The remote pay server system in accordance with claim 19,
said computer-executable instructions causing the processor to perform an operation comprising:
receiving a payment authorization response message from the second card issuer computing device authorizing the payment transaction; and
transmitting the payment authorization response message to the first POS terminal.
